(19) United States
(12) Patent Application Publication
(10) Pub. No.: US 2007/0289691 A1
(43) Pub. Date: Dec. 20, 2007

(54) Method of manufacturing non-shrinkage ceramic substrate

(76) Inventors: Yong Suk Kim, Yongin (KR); Young Soo Oh, Seongnam (KR); Byeung Gyu Chang, Suwon (KR); Sung Yeol Park, Gunpo (KR); Ki Pyo Hong, Yongin (KR)

Correspondence Address: MCDERMOTT WILL & EMERY LLP, 600 13TH STREET, N.W., WASHINGTON, DC, 20005-3096, US

(21) Appl. No.: 11/808,929

(22) Filed: Jun. 13, 2007

(30) Foreign Application Priority Data
Jun. 13, 2006 (KR) 10-2006-0052812

(51) Int. Cl. C03B 29/00

(52) U.S. Cl. 156/89.12; 156/89.16

(57) ABSTRACT

A method of manufacturing a non-shrinkage ceramic substrate comprises preparing a plurality of green sheets; forming internal electrodes and conductive vias in the respective green sheets; laminating the plurality of green sheets to form a multilayer ceramic substrate; forming a constrained layer on the top and bottom surfaces of the multilayer ceramic substrate by using one or more methods selected from the group consisting of an ALD (Atomic Layer Deposition) method, a sputtering method, a CVD (Chemical Vapor Deposition) method, and a sol-gel method, the constrained layer not being fired at the firing temperature of the green sheet; firing the resultant structure at the firing temperature of the green sheet; and removing the constrained layer.

### CROSS-REFERENCE TO RELATED APPLICATIONS

This application claims the benefit of Korean Patent Application No. 10-2006-0052812 filed with the Korean Intellectual Property Office on Jun. 13, 2006, the disclosure of which is incorporated herein by reference.

### BACKGROUND OF THE INVENTION

1. Field of the Invention

The present invention relates to a method of manufacturing a non-shrinkage ceramic substrate which can control deviations in X-Y direction shrinkage rate and surface-direction shrinkage rate of a ceramic substrate such that the edge of the substrate is prevented from being bent.

2. Description of the Related Art

Multilayer ceramic substrates are widely used as substitutes of existing printed circuit boards, because they have a heat-resisting property, a wear-resisting property, and an excellent electrical characteristic. Further, demands for the multilayer ceramic substrates gradually increase.

Such multilayer ceramic substrates are used as parts in which active elements such as semiconductor IC chips and passive elements such as a capacitor, an inductor, and a resistor are combined or are used as simple semiconductor IC packages. More specifically, the multilayer ceramic substrates are widely used for manufacturing various electronic parts such as PA module substrates, RF diode switches, filters, chip antennas, various package parts, complex devices and the like.

A multilayer ceramic substrate includes a plurality of laminated ceramic layers. Such a multilayer ceramic substrate has various types of wiring conductors formed therein. As for the wiring conductors in the multilayer ceramic substrate, internal electrodes are formed to extend along a specific interface between the ceramic layers, conductive vias passing through specific ceramic layers are formed to extend, and external electrodes are formed to extend along the outer surface of the multilayer ceramic substrate.

To obtain a multifunctional, high-density, and high-performance multilayer ceramic substrate, the above-described wiring conductors must be disposed at high density.

In general, such a multilayer ceramic substrate is manufactured by a green sheet lamination method. This method is where via holes are formed in green sheets obtained by forming slurry composed of ceramic powder and organic binder, conductive paste is screen-printed, and a required number of greet sheets are overlapped, heated, pressurized, laminated, and fired to thereby obtain the multilayer ceramic substrate.

In the green sheet lamination method, since the softness of green sheets is enhanced and an organic solvent is easily absorbed, printing of micro patterns can be performed. Further, it is possible to achieve flatness and airtightness required for a multilayer ceramic substrate having several dozens of layers.

On the other hand, in order to laminate green sheets having wiring conductors formed therein and to obtain excellent characteristics, a firing process must be performed. After such a firing process, the ceramic substrate is shrunk by the firing.

The shrinkage does not uniformly occur in the entire multilayer ceramic substrate, thereby causing the ceramic substrate to be deformed with respect to a surface direction of the ceramic layer.

The surface-direction shrinkage causes wiring conductors to be deformed or distorted. More specifically, positional precision of external electrodes for connecting chip parts or the like to be mounted on the multilayer ceramic substrate is reduced, or cutting of wire can occur in the wiring conductors.

Recently, there is proposed a non-shrinkage method which eliminates a surface-direction shrinkage during a firing process, when a multilayer ceramic substrate is manufactured.

In a generally-applied non-shrinkage method, a constrained layer is formed using Al₂O₃ powder which is not sintered at less than 900° C. and is then laminated on the top and bottom surfaces of a ceramic substrate formed of low-temperature co-fired ceramic (LTCC) green sheets. Then, pressure is applied to the top and bottom surfaces of the ceramic substrate, and the ceramic substrate is plasticized and fired. After that, the constrained layer is removed to obtain a ceramic substrate.

However, when such a conventional non-shrinkage method is applied to manufacture a ceramic substrate, the substrate can be bent, and a surface-direction shrinkage rate can be ill-balanced, because of defective lamination at the interface between a constrained layer and the ceramic substrate.

Referring to FIGS. 1 to 4, the problems of the conventional method of manufacturing a non-shrinkage ceramic substrate will be described in detail.

FIGS. 1 to 3 are sectional views sequentially showing a process for explaining the conventional method of manufacturing a non-shrinkage ceramic substrate. FIG. 4 is a plan view of the non-shrinkage ceramic substrate shown in FIG. 3.

As shown in FIG. 1, a plurality of green sheets 10 are prepared, in which internal electrodes 20 and conductive vias 30 for connecting electrodes of different layers from each other are formed in accordance with a module circuit diagram. Then, the plurality of green sheets 10 are laminated to form a multilayer ceramic substrate 100. Preferably, the green sheets 10 have a firing temperature of 800-900° C.

Next, a constrained layer 40 which is not fired at the firing temperature of the green sheet 10, for example, an Al₂O₃ sheet is laminated on the top and bottom surfaces of the multilayer ceramic substrate 100. The constrained layer 40 is generally formed by the following method. Slurry formed by uniformly dispersing ceramic powder or the like is thinly coated on a polymer supporting film such as PET (Polyethylene Terephthalate) or the like by using a die coater or a doctor blade. Then, the coated slurry is dried to form a constrained layer.

Then, as shown in FIG. 2, the resultant structure is pressurized, plasticized, and fired. Arrows of FIG. 2 indicate a direction where pressure is applied.

Preferably, the firing of the resultant structure is performed at a temperature of 800-900° C. which is the firing temperature of the green sheet 10. At this time, since the constrained layer 40 formed of Al₂O₃ is fired at a temperature of more than 1500° C., no firing deformation occurs in the above-described temperature range. The constrained layer 40 prevents the green sheets 10 forming the multilayer ceramic substrate 100 from being shrunk in a surface direction, while the firing is performed.

In the conventional method of manufacturing a non-shrinkage ceramic substrate, however, when the constrained layer 40 is formed by the above-described method and is then laminated on the top and bottom surfaces of the multilayer ceramic substrate 100, a bonding force between particles at the interface between the constrained layer 40 and the multilayer ceramic substrate 100 is weakened during the firing process such that a constraining force of the constrained layer 40 is reduced, and a gap (represented by “V” in FIG. 2) is generated at the interface. Therefore, the deviations in X-Y direction shrinkage rate and surface-direction shrinkage rate of the substrate cannot be controlled so that the substrate can be bent.

Further, after the firing process, a lapping process for removing the constrained layer 40 is essentially performed. After the lapping process is performed in a state where the gap V or the like is generated, the thicknesses of the green sheets 10 are not uniform, and the surface roughness of the substrate becomes non-uniform, as shown in FIGS. 3 and 4. Therefore, when patterns such as external electrodes to be subsequently formed are printed, process precision is reduced, and a product quality is reduced.

### SUMMARY OF THE INVENTION

An advantage of the present invention is that it provides a method of manufacturing a non-shrinkage ceramic substrate, which can strengthen a constraining force of a constrained layer to control deviations in X-Y direction shrinkage rate and surface-direction shrinkage rate of a substrate and can prevent the substrate from being bent, thereby enhancing a product quality.

Additional aspect and advantages of the present general inventive concept will be set forth in part in the description which follows and, in part, will be obvious from the description, or may be learned by practice of the general inventive concept.

According to an aspect of the invention, a method of manufacturing a non-shrinkage ceramic substrate comprises preparing a plurality of green sheets; forming internal electrodes and conductive vias in the respective green sheets; laminating the plurality of green sheets to form a multilayer ceramic substrate; forming a constrained layer on the top and bottom surfaces of the multilayer ceramic substrate by using one or more methods selected from the group consisting of an ALD (Atomic Layer Deposition) method, a sputtering method, a CVD (Chemical Vapor Deposition) method, and a sol-gel method, the constrained layer not being fired at the firing temperature of the green sheet; firing the resultant structure at the firing temperature of the green sheet; and removing the constrained layer.

Preferably, when the constrained layer is formed by the ALD method, an Al₂O₃ thin film with a required thickness is deposited by repeating a cycle including: flowing AlCl₃ and Al(O¹Pr)₃ as precursor; purging Ar as purge gas; flowing water vapor as oxygen reaction gas; and purging Ar as purge gas.

Preferably, as for Al(O¹Pr)₃, any one of (CH₃)₂AlOCH(CH₃)₂, dimethylaluminum isopropoxide (DMAP), Al(OC(CH₃)₃)₃, and dimethylaluminum sec-butoxide (DMAB) is used.

Preferably, when the constrained layer is formed by the sputtering method, Al₂O₃ is used as a target material, and an Al₂O₃ thin film is deposited by using Ar as carrier gas.

Preferably, when the constrained layer is formed by the CVD method, an Al₂O₃ thin film is deposited by using dimethylaluminum isopropoxide (DMAP) as precursor.

Preferably, when the constrained layer is formed by the sol-gel method, a spin coat method is applied.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIGS. 1 to 3 are sectional views sequentially showing a process for explaining a conventional method of manufacturing a non-shrinkage ceramic substrate;

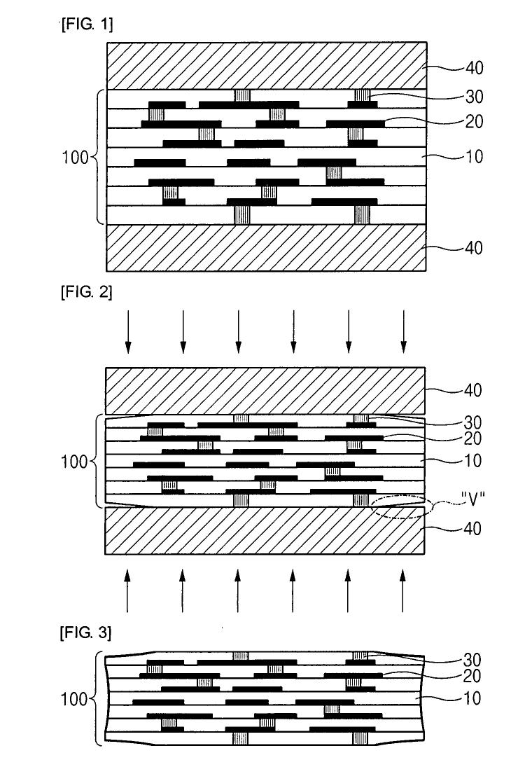

FIG. 4 is a plan view of the non-shrinkage ceramic substrate shown in FIG. 3;

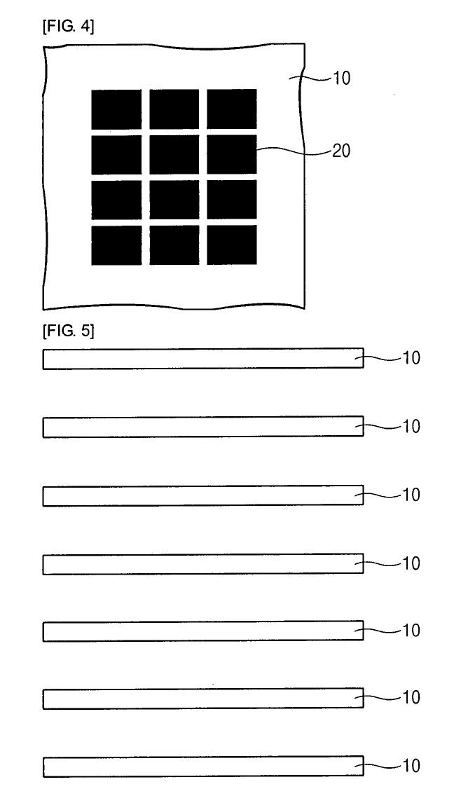

FIGS. 5 to 11 are sectional views sequentially showing a process for explaining the method of manufacturing a non-shrinkage ceramic substrate according to an embodiment of the invention; and

FIG. 12A is a graph showing the surface roughness of a conventional ceramic substrate after a constrained layer is removed;

FIG. 12B is a graph showing the surface roughness of the ceramic substrate according to the invention after a constrained layer is removed; and

FIG. 12C is a graph showing the surface roughness of the ceramic substrate according to the invention after a constrained layer formed by the sputtering method is removed.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to like elements throughout. The embodiments are described below in order to explain the present general inventive concept by referring to the figures. In the drawings, the thicknesses of layers and regions are exaggerated for clarity.

Hereinafter, a method of manufacturing non-shrinkage ceramic substrate according to an embodiment of the present invention will be described in detail with reference to the accompanying drawings.

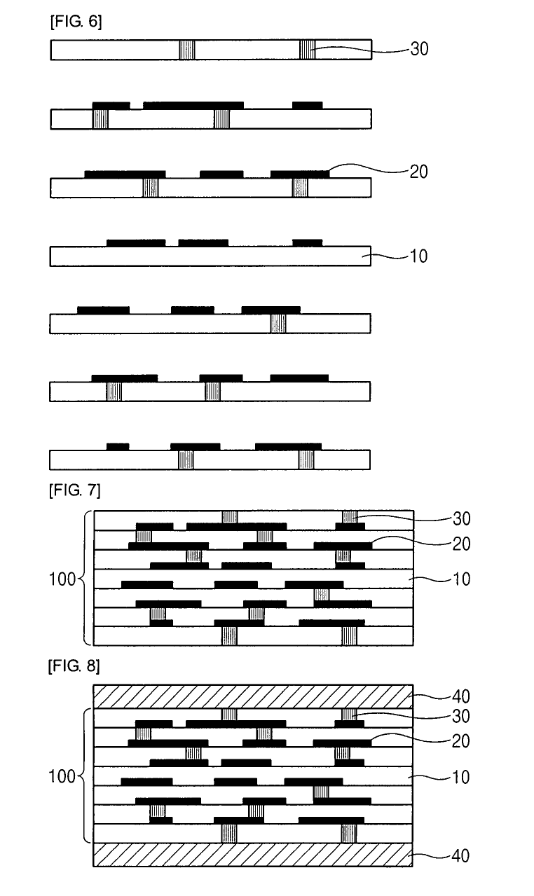

FIGS. 5 to 11 are sectional views sequentially showing a process for explaining the method of manufacturing a non-shrinkage ceramic substrate according to an embodiment of the invention.

As shown in FIG. 5, a plurality of green sheets 10 are first prepared. The green sheet 10 may be formed of a material in which ceramic powder, dispersing agents, solvent, polymer binders, plasticizers, and other additives, if necessary, are combined at a predetermined ratio. Preferably, the green sheet 10 has a firing temperature of 800-900° C.

Next, as shown in FIG. 6, internal electrodes 20 are formed at proper positions of the green sheets 10 in accordance with a module circuit diagram. Further, some of the green sheets 10 are processed by punching or the like such that via holes (not shown) are formed therein. Then, conductive paste is filled into the via holes such that conductive vias 30 are formed to vertically pass through some of the green sheets 10. The conductive vias 30 electrically connect electrodes formed in different layers from each other. The internal electrodes 20 and the conductive vias 30 may be formed by a screen printing method using conductive paste such as Ag or the like.

Subsequently, as shown in FIG. 7, the plurality of green sheets 10 are laminated, thereby forming a multilayer ceramic substrate 100.

Then, as shown in FIG. 8, a constrained layer 40, which is not fired at the firing temperature of the green sheet 10, for example, an Al₂O₃ thin film is formed on the top and bottom surface of the multilayer ceramic substrate 100. Preferably, the constrained layer 40 formed of an Al₂O₃ thin film is formed by one or more methods selected from the group consisting of an ALD (Atomic Layer Deposition) method, a sputtering method, a CVD (Chemical Vapor Deposition) method, and a sol-gel method. The above-described methods all facilitates the formation of thin film.

Among the methods for forming the constrained layer 40, when the constrained layer 40 is formed using the ALD method, a substrate temperature is maintained at about 150° C., the pressure of a reaction chamber is maintained at 2.5-5.0 torr, preferably, at 4.5 torr, and the temperature of the reaction chamber is maintained at 120-170° C., preferably, at 150° C., in order to obtain a fine layer quality. Then, the following cycle is repeated to deposit a constrained layer at a thickness of several dozens to several hundreds . The cycle includes flowing AlCl₃ and Al(O¹Pr)₃ as precursor at 0.5 cc/sec, purging Ar as purge gas at 0.5 cc/sec, flowing water vapor as oxygen reaction gas 0.5 cc/sec, and purging Ar as purge gas at 0.5 cc/sec. For example, an Al₂O₃ thin film having a required thickness (several dozens to several hundreds ) can be deposited by repeating the cycle. As for Al(O¹Pr)₃, any one of (CH₃)₂AlOCH(CH₃)₂, dimethylaluminum isopropoxide (DMAP), Al(OC(CH₃)₃)₃, and dimethylaluminum sec-butoxide (DMAB) can be used. Among them, when the dimethylaluminum isopropoxide (DMAP) is used, the temperature of DMAP is maintained preferably at 85-90° C. When the dimethylaluminum sec-butoxide (DMAB) is used, the temperature of the DMAB is maintained preferably at about 120° C.

When the constrained layer 40 is formed by the sputtering method, Al₂O₃ is used as a target material, a substrate temperature is maintained at 80-120° C., preferably, at 90° C., vacuum pressure is maintained at 5×10⁻³-5×10⁻⁴ torr, and Ar is used as carrier gas and is injected at 5-10 cc/min, under a condition with RF power of 600 W and a frequency of 13.5 Mhz. When the vacuum pressure is maintained, an Al₂O₃ thin film can be deposited at a thickness of several μm while the injection of Ar is maintained for 3-20 minutes, preferably, for ten minutes.

When the constrained layer 40 is formed by the CVD method, the dimethylaluminum isopropoxide (DMAP) is used as precursor, a substrate temperature is maintained at about 180° C., the pressure of the reaction chamber is maintained at 10⁻³-10⁻⁴ torr, preferably, at 3×10⁻³, and the temperature of the reaction chamber is maintained at about 90° C. Then, an Al₂O₃ thin film can be deposited at a thickness of several hundreds

When the constrained layer 40 is formed by the sol-gel method, an Al-based alkoxide solution is mixed with alumina powder so as to make a mixed alkoxide solution, and the mixed alkoxide solution is partially hydrolyzed to make a sol solution. Then, the sol solution is coated on a substrate by a spin coat process and is then dried to thereby manufacture a constrained layer.

Next, as shown in FIG. 9, the resultant structure is pressurized, plasticized, and fired. In this case, arrows of FIG. 9 indicate a direction where pressure is applied. Preferably, the firing is performed at 800-900° C. which is the firing temperature of the green sheet 10. At this time, the constrained layer 40 is not deformed in the above-described range of the firing temperature, because the constrained layer formed of Al₂O₃ is fired at more than 1500° C. While the firing is performed, the constrained layer 40 prevents the green sheets 10 forming the multilayer ceramic substrate 100 from being shrunk in the surface direction.

According to this embodiment, the constrained layer 40 is formed as a very thin film by the ALD method, the sputtering method, the CVD, or the sol-gel method. Therefore, the constrained layer 40 can be easily removed after the firing. Further, when the constrained layer 40 is formed in the above-described manner, a reaction layer (not shown) is formed at the interface between the constrained layer 40 and the multilayer ceramic substrate 100 during firing. The reaction layer strengthens a bonding force between particles forming the constrained layer 40 and the multilayer ceramic substrate 100, thereby preventing a gap from being generated at the interface and strengthening a constraining force. Therefore, the deviations in X-Y direction shrinkage rate and surface-direction shrinkage rate of the substrate after the firing can be controlled, and the substrate can be prevented from being bent.

Table 1 comparatively shows the X-Y direction shrinkage rate of the ceramic substrate according to the invention before and after firing and the X-Y direction shrinkage rate of the conventional ceramic substrate art before and after firing.

TABLE 1

| SPL No. | Conventional method | ALD | Sputter |
|---|---|---|---|
| 1 | 0.4382 | 0.3730 | 0.2746 |
| 2 | 0.4311 | 0.3680 | 0.2859 |
| 3 | 0.4509 | 0.3356 | 0.2993 |
| 4 | 0.4304 | 0.3503 | 0.3045 |
| 5 | 0.5261 | 0.3512 | 0.3054 |
| 6 | 0.5260 | 0.3418 | 0.3152 |
| 7 | 0.4447 | 0.3443 | 0.2971 |
| 8 | 0.4012 | 0.3691 | 0.2995 |
| 9 | 0.4534 | 0.3438 | 0.2872 |
| 10 | 0.4700 | 0.3626 | 0.2836 |
| Average | 0.4572 | 0.3539 | 0.2952 |
| Standard deviation | 0.0405 | 0.0132 | 0.0122 |

As shown in Table 1, the average of the X-Y direction firing shrinkage rates of the ceramic substrate according to the invention is 0.3539 when the constrained layer formed by the ALD method is applied and 0.2952 when the constrained layer formed by the sputtering method is applied, which means that the average is much smaller than that (0.4572) of the X-Y direction shrinkage rates of the conventional ceramic substrate. Further, the standard deviation of the firing shrinkage rates of the ceramic substrate according to the invention is much smaller than that of the conventional ceramic substrate. Through this, a capability of controlling the deviations in the X-Y direction firing shrinkage rate and the surface-direction firing shrinkage rate in the invention can be obviously verified.

Next, as shown in FIG. 10, the constrained layer 10 is removed.

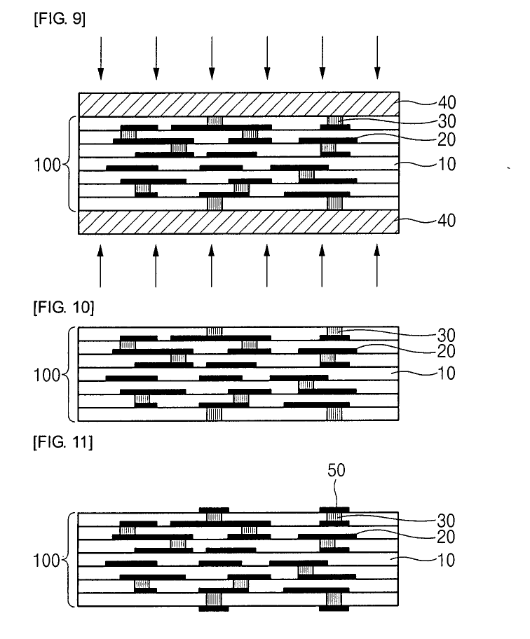

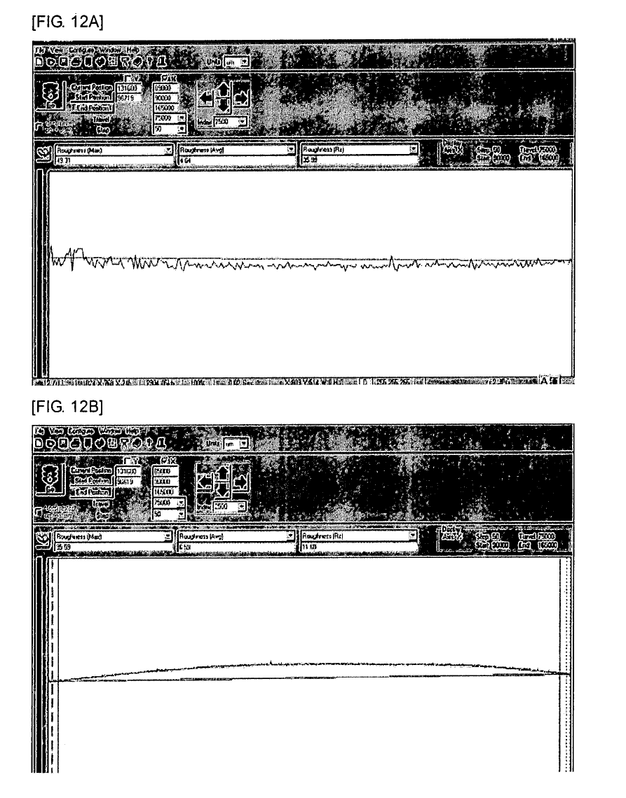

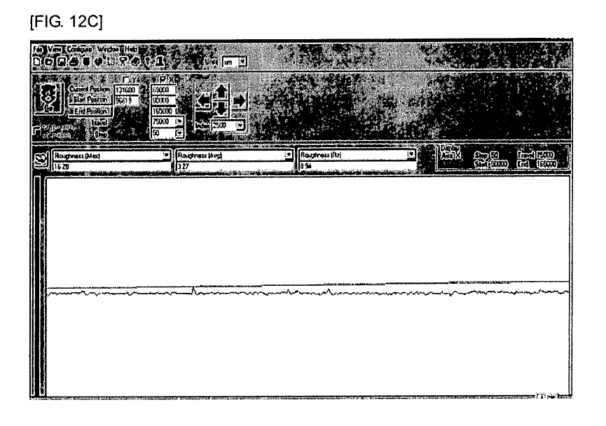

Table 2 comparatively shows surface roughness of the ceramic substrate according to the invention and surface roughness of the conventional ceramic substrate after the constrained layer is removed. FIGS. 12A to 12C are graphs showing data of Table 2. FIG. 12A shows the surface roughness of the conventional ceramic substrate after the constrained layer is removed. FIG. 12B shows the surface roughness of the ceramic substrate according to the invention after the constrained layer is removed. FIG. 12C shows the surface roughness of the ceramic substrate according to the invention after the constrained layer formed by the sputtering method is removed.

In table 2, R(AVG) represents an average of surface roughnesses, R(Z) represents an intermediate value of measured surface roughnesses from which the maximum and minimum values are omitted, and R(Max) represents the maximum value of the measured surface roughnesses.

TABLE 2

| | R(AVG), μm | R(Z), μm | R(Max), μm |
|---|---|---|---|
| Conventional method | 4.64 | 35.98 | 49.31 |
| ALD | 6.59 | 11.68 | 35.59 |
| Sputter | 3.27 | 8.94 | 16.28 |

As shown in Table 2 and FIGS. 12A to 12C, it can be found that, when the constrained layer is formed by the ALD method and the sputtering method, the surface roughness of the ceramic substrate after the constrained layer is removed is much smaller than that of the conventional ceramic substrate.

Therefore, in the invention, it is possible to uniformize the overall thickness of the ceramic substrate after the constrained layer is removed. Accordingly, when patterns such as external electrodes 50 or the like to be subsequently formed are printed, process precision is prevented from being reduced, which makes it possible to a product quality.

Next, as shown in FIG. 11, external electrodes 50 are formed on the top and bottom surfaces of the multilayer ceramic substrate 100, the external electrodes 50 being connected to the conductive vias 30 exposed by removing the constrained layer 40. The external electrodes 50 can be electrically connected to the internal electrodes 20, formed in the multilayer ceramic substrate 100, through the conductive vias 30.

According to the method of manufacturing a non-shrinkage ceramic substrate, the constrained layer is very thinly formed on the top and bottom surfaces of the multilayer ceramic substrate by one or more of the ALD method, the sputtering method, the CVD method, and the sol-gel method. Therefore, after firing, the constrained layer can be easily removed.

Further, when firing is performed, the reaction layer is formed at the interface between the constrained layer and the multilayer ceramic substrate such that a bonding force between the constrained layer and the multilayer ceramic substrate can be strengthened. Therefore, a gap can be prevented from being generated at the interface, and a constraining force of the constrained layer can be further strengthened. Accordingly, it is possible to control the deviations in the X-Y direction shrinkage rate and the surface-direction shrinkage rate of the substrate before and after firing and to prevent the substrate from being deformed.

In addition, the overall thickness of the ceramic substrate after the constrained layer is removed can be uniformized. Therefore, when patterns such as the external electrodes to be subsequently formed are printed, process precision is prevented from being reduced, which makes it possible to enhance a product quality.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A method of manufacturing a non-shrinkage ceramic substrate comprising:
preparing a plurality of green sheets;
forming internal electrodes and conductive vias in the respective green sheets;
laminating the plurality of green sheets to form a multilayer ceramic substrate;
forming a constrained layer on the top and bottom surfaces of the multilayer ceramic substrate by using one or more methods selected from the group consisting of an ALD (Atomic Layer Deposition) method, a sputtering method, a CVD (Chemical Vapor Deposition) method, and a sol-gel method, the constrained layer not being fired at the firing temperature of the green sheet;
firing the resultant structure at the firing temperature of the green sheet; and
removing the constrained layer.

2. The method according to claim 1,
wherein when the constrained layer is formed by the ALD method, an Al₂O₃ thin film with a required thickness is deposited by repeating a cycle,
the cycle including:
flowing AlCl₃ and Al(O¹Pr)₃ as precursor;
purging Ar as purge gas;
flowing water vapor as oxygen reaction gas; and
purging Ar as purge gas.

3. The method according to claim 2,
wherein as for Al(O¹Pr)₃, any one of (CH₃)₂AlOCH(CH₃)₂, dimethylaluminum isopropoxide (DMAP), Al(OC(CH₃)₃)₃, and dimethylaluminum sec-butoxide (DMAB) is used.

4. The method according to claim 1,
wherein when the constrained layer is formed by the sputtering method, Al₂O₃ is used as a target material, and an Al₂O₃ thin film is deposited by using Ar as carrier gas.

5. The method according to claim 1,
wherein when the constrained layer is formed by the CVD method, an Al₂O₃ thin film is deposited by using dimethylaluminum isopropoxide (DMAP) as precursor.

6. The method according to claim 1,
wherein when the constrained layer is formed by the sol-gel method, a spin coat method is applied.
